(19) United States
(12) Patent Application Publication
(10) Pub. No.: US 2025/0371480 A1
(43) Pub. Date: Dec. 4, 2025

(54) PLUGIN-BASED MAPPING OF ERP TRANSACTIONAL DATA TO CONTRACT RECORDS USING DIRECT AND INDIRECT RELATIONSHIP TYPES

(71) Applicant: COGNITUS CONSULTING LLC, Dallas, TX (US)

(72) Inventor: Christopher Skinner, Aubrey, TX (US)

(73) Assignee: COGNITUS CONSULTING LLC, Dallas, TX (US)

(21) Appl. No.: 19/221,106

(22) Filed: May 28, 2025

Related U.S. Application Data
(63) Continuation-in-part of application No. 18/675,386, filed on May 28, 2024.

(51) Int. Cl. G06Q 10/067; G06Q 10/0631

(52) U.S. Cl. CPC G06Q 10/067; G06Q 10/0631

(57) ABSTRACT

A plugin application for an enterprise resource planning (“ERP”) system enables configurable mapping between transactional records and contract data. The plugin provides a graphical user interface through which users can select a primary table and define either direct or indirect relationships. In a direct relationship, fields in the transactional table are directly matched to contract item fields. In an indirect relationship, intermediate references—such as billing elements or internal identifiers—are mapped to contract billing objects. The system supports special relationship types, including intercompany mappings, where transactional records from different company codes are associated using cross-company data. Mappings are stored in a mapping table and applied during runtime to resolve ERP records to contractual structures. The solution supports flexible billing, reporting, and reconciliation processes without requiring hardcoded logic or custom development.

### CROSS-REFERENCES TO RELATED APPLICATIONS

This application is a Continuation-in-part of patent application Ser. No. 18/675,386 entitled “REAL-TIME PROCESSING OF BILLING TRANSACTIONS FROM AN ENTERPRISE RESOURCE PLANNING SYSTEM”, filed on May 28, 2024, by COGNITUS CONSUTING, LCC, which is herein incorporated in its entirety by reference for all purposes.

### BACKGROUND

Enterprise resource planning (“ERP”) systems are widely used by organizations to manage business processes involving finance, logistics, human resources, and project execution. One critical function of ERP systems is the ability to track and reconcile financial transactions against contractually defined obligations. For example, transactions such as time entries, goods receipts, and service confirmations must often be associated with contract line items in order to drive billing, cost recovery, compliance tracking, or internal chargeback processes.

In complex ERP environments, transactional data is frequently stored in a consolidated structure, such as the Universal Journal table (ACDOCA) in SAP S/4HANA. While this structure provides a unified record of financial and controlling activity, the linkage between transactional entries and contract data is not always explicitly present. In some cases, relevant contract identifiers are recorded directly in transactional entries. In many other cases, the linkage is indirect and must be inferred from intermediate data points such as internal orders, work breakdown structure (“WBS”) elements, or intercompany billing references.

Traditional ERP customization approaches require extensive development effort to define and maintain these linkage rules, often relying on hardcoded logic or ad hoc data joins that are difficult to manage, audit, or adapt across business scenarios. This lack of configurability presents challenges when dealing with heterogeneous contract sources, evolving organizational structures, or non-standard billing arrangements.

One particular challenge arises in intercompany billing scenarios, where one company code performs work or delivers services on behalf of another. In such cases, the transactional record may reference internal customers, project structures, or cross-company postings, but may not contain a direct reference to the governing contract. Similar challenges exist in project-based billing, where WBS elements are used to collect costs and must later be mapped to external or internal contracts for reconciliation.

Accordingly, there is a need for a configurable and extensible mechanism that allows users to define both direct and indirect relationships between transactional records and contract data.

### SUMMARY

This disclosure relates to systems and methods for mapping transactional data to contractual structures within an ERP environment. In particular, the disclosure provides a plugin application that enables users to define configurable mappings between a primary table—such as the Universal Journal table (ACDOCA) in SAP—and a source of contract data. The plugin supports both direct relationships, in which transactional records contain explicit references to contract items, and indirect relationships, in which the association is made via intermediate objects such as billing elements or internal references.

A graphical user interface is provided to guide users through the mapping configuration process. Users may select a primary data source, choose a relationship type, and define field-level mappings using field pairing interfaces. For direct relationships, fields in the transactional record are directly matched to fields in the contract file. For indirect relationships, mappings are defined between intermediary identifiers—such as WBS billing elements or internal order numbers—and contract billing objects.

The system further supports specialized mapping types, including intercompany relationships, in which cross-company activity is identified and mapped by associating delivering and receiving company codes. These relationships may be used to support internal billing, transfer pricing, and other forms of intercompany reconciliation, even in the absence of explicit contract identifiers.

At runtime, the plugin applies the stored mapping definitions to transactional records in the ERP system. It resolves the applicable contract associations by applying direct lookups or indirect dereferencing operations based on the selected mapping type. The resolved associations may be used for pricing, billing, cost allocation, reporting, or compliance purposes.

The disclosed approach provides a flexible, extensible framework for associating ERP transactions with contractual obligations, supporting both standardized and specialized use cases across financial, project, and intercompany processes.

Both the foregoing general description and the following detailed description are exemplary and explanatory only and are not restrictive of the examples, as claimed.

### BRIEF DESCRIPTION OF THE DRAWINGS

FIG. 1 is a flowchart of an example method for providing a GUI for data source customization in an ERP system.

FIG. 2 is a flowchart of an example method for providing a GUI for data source customization in an ERP system.

FIG. 3 is a sequence diagram of an example method for providing a GUI for data source customization in an ERP system.

FIG. 4 is an illustration of an example GUI for data source customization in an ERP system.

FIG. 5 is an illustration of another example GUI for data source customization in an ERP system.

FIG. 6 is an illustration of example data mapping window in a GUI for data source customization in an ERP system.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

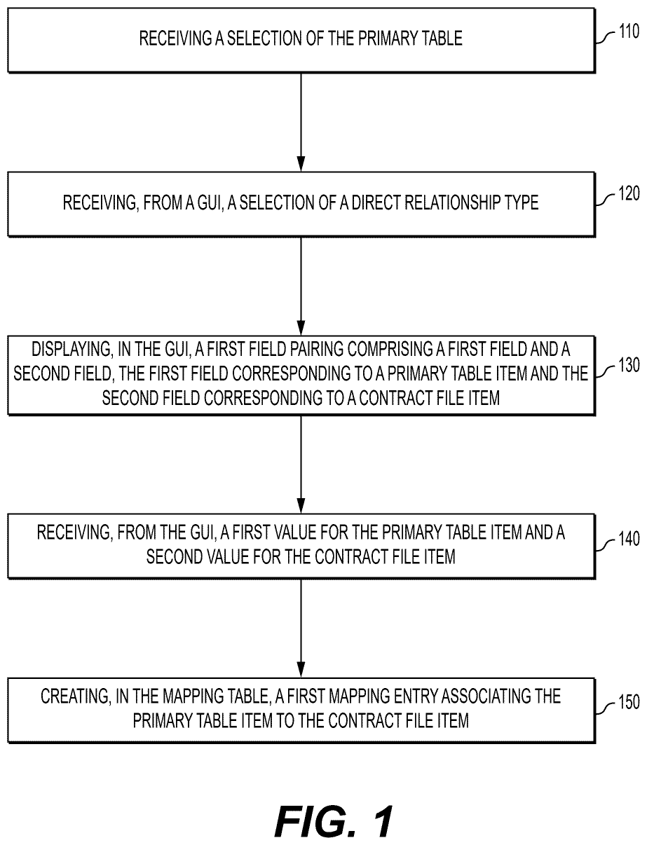

FIG. 1 is a flowchart of an example method for mapping a direct relationship between elements a primary document of an ERP system and a contract document. Prior to stage 110 below, a contract file can be uploaded to the ERP system. The contract can be uploaded manually by a user through a GUI or automatically through an integration with an external contract management or procurement system. In some examples, the contract can be formatted in a structured file format, such as extensible markup langue (“XML”), JavaScript Object Notation (“JSON”), or a proprietary flat file, and may include metadata as well as one or more contract items. In some examples, the contract can be formatted in an unstructured format, such as a Portable Document Format (“pdf”) file, and the RTB application can use language processing techniques to read text in the file, such as optical character recognition (“OCR”) and natural language processing (“NLP”).

Upon receipt of the contract, the ERP system can store the contract data in one or more contract data tables. Each contract item may be defined by a set of attributes, including but not limited to an item identifier, item type, quantity, unit price, delivery terms, and associated account assignment information.

A plugin application (referred to hereinafter as a Realtime Billing (“RTB”) application) integrated with the ERP system can be configured to detect newly uploaded contracts. In some embodiments, the plugin monitors a designated data source, such as a database table, message queue, or file directory, for new contract records. Upon detection of a new contract, the plugin retrieves the contract data for processing.

The plugin can parse the contract data to extract contract item types. This parsing can be performed using a rule-based engine, schema mapping, or predefined data extraction templates. The contract item type can correspond to different categories of contract items, such as materials, services, usage-based components, or time-and-materials entries. The extracted item types are used by the plugin to facilitate downstream mapping logic between contract items and transactional records stored in the ERP system's financial tables, such as the Universal Journal (e.g., ACDOCA).

In some implementations, the RTB application can normalize the extracted contract item types to a standardized format, allowing for consistent treatment across heterogeneous data sources. The extracted information is stored in an internal data structure and may be surfaced to the user through a GUI to support subsequent mapping actions, including the creation of direct or indirect relationships between contract items and financial or billing-related ERP objects.

The tables described herein, such as configuration, logic, and data tables (both virtual and real), can exist either within or outside of the ERP system, depending on the deployment model. For example, in one deployment model, the RTB application is installed directly into the ERP system and becomes an integrated part of its codebase via extensibility mechanisms of the ERP system. In another deployment model, the RTB application is installed in a standalone server, container, or cloud service platform and is connected to the ERP system via Application Programming Interfaces (“APIs”) to send and receive data from the ERP system. This method is required when the ERP system is a multi-tenant system without provisions for on-stack enhancement.

At stage 110, an RTB application can receive, via a GUI, a selection of a primary table. The GUI may be rendered within a browser-based environment, a standalone application, or a native ERP interface, depending on the deployment architecture of the RTP application. The selection can be made from a dropdown menu, search field, or other input component configured to present available data sources.

The primary table represents the transactional data structure from which mappings are generated. As an example, in SAP, the selected primary table can correspond to the ACDOCA table in S/4HANA. ACDOCA is the Universal Journal table in SAP that consolidates financial and controlling information and includes line-item-level entries corresponding to a wide variety of document types, including general ledger postings, controlling entries, asset transactions, and project-related billings.

The RTB application can validate the selected table to ensure compatibility with the mapping logic. In some cases, metadata associated with the primary table—such as available field names, field types, and key structures—is retrieved at this stage to enable downstream configuration steps, including field pairing and mapping rule creation. The selection of the primary table establishes the source context for subsequent operations, including the definition of field relationships between contract data and transactional entries.

At stage 120, the RTB application can receive a selection of a direct relationship type. For example, in response to the selection of the primary table, the GUI can present selectable options for defining a relationship type. The relationship type governs how entries in the primary table are to be associated with contract data. The available relationship types include at least a direct relationship and an indirect relationship.

The direct relationship type corresponds to a mapping configuration in which one or more fields in the primary table contain values that can be matched directly to fields in a contract data source. For example, in scenarios where the primary table is the ACDOCA table in SAP, such fields can include a contract number and a contract item number that are embedded within individual ACDOCA entries and correspond directly to identifiers used in the contract data.

The selection of the direct relationship type can trigger the RTB application to configure subsequent stages of the user interface to support the definition of direct field pairings. These field pairings enable users to specify which fields in the primary table correspond to which fields in the contract, facilitating a one-to-one mapping relationship between transactional records and contract elements. The plugin can also use this selection to pre-load field metadata from the primary table to assist the user in selecting valid field combinations during the mapping definition process.

At stage 130, the RTB application can display, in the GUI, a field pairing interface comprising a first field corresponding to a data element in the primary table, and a second field corresponding to a data element in the contract file.

The first field can represent an attribute in the primary table that is used to uniquely identify or associate a transactional record with a contract entry. For example, where the primary table is ACDOCA, the first field may correspond to a field such as a contract number (e.g., VBELN) or contract item number (e.g., POSNR). The second field can represent a corresponding identifier in the contract file, such as a contract ID, contract line item number, or external reference key.

The RTB application can retrieve metadata from both the primary table and the contract file to populate selectable field options. In some embodiments, the GUI allows the user to manually select the fields from dropdown menus, auto-complete inputs, or drag-and-drop components. The field pairing enables the user to define how entries in the primary table are to be matched with items in the contract file based on field-level equivalence.

The display of the field pairing at this stage initiates the configuration of a direct mapping, allowing the user to proceed with assigning values or rules that govern the relationship between the identified fields.

At stage 140, the RTB application can receive, from the GUI, input values corresponding to the selected fields. Specifically, the RTB application can receive a first value associated with the field from the primary table and a second value associated with the field from the contract file.

The first value can correspond to a specific data entry in the primary table, such as a contract number or contract item number extracted from a transactional record, for example, an entry in the ACDOCA table. The second value may correspond to an identifier used in the contract file to represent a contract-level entity or a contract item. These values define a concrete instance of a mapping relationship between a transactional record and a contract reference.

The user can provide the input values through one or more input controls rendered in the GUI, such as text fields, dropdown menus, or lookup selectors. In some embodiments, the RTB application can perform validation on the received values, such as verifying the existence of the contract reference or confirming that the primary table value conforms to expected data formats or constraints.

The received values can temporarily stored in an internal representation and prepared for insertion into a persistent mapping structure, as described in subsequent stages. This input stage enables the creation of a direct association between transactional data and contract data for downstream processing and reconciliation.

At stage 150, the RTB application can create, in the mapping table, a first mapping entry in a mapping table that associates the value corresponding to the selected field from the primary table with the value corresponding to the selected field from the contract file.

The mapping table serves as a persistent data structure used by the RTB application to store relationship definitions between transactional data and contract data. Each entry in the mapping table includes at least two data fields: one referencing an item from the primary table (e.g., a contract number or item number from ACDOCA), and one referencing an item from the contract file (e.g., a contract item identifier).

The first mapping entry created at this stage represents a direct mapping relationship, enabling the RTB application to later identify, process, or reconcile entries in the primary table based on their correspondence to specific contract items. In some embodiments, the mapping table may include additional metadata associated with the mapping entry, such as a timestamp, user identifier, or mapping type indicator, to support versioning, auditability, and filtering in downstream processes.

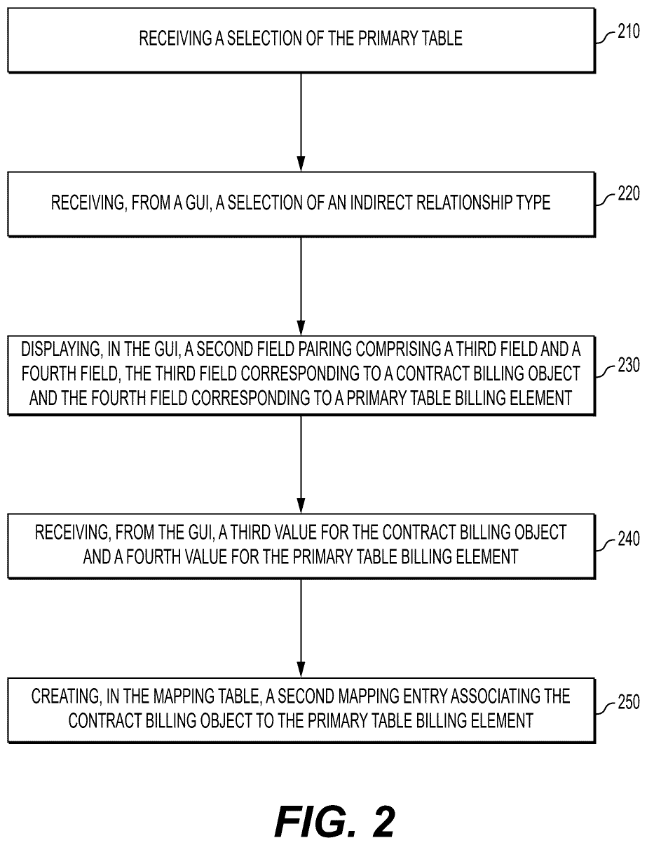

FIG. 2 is a flowchart of an example method for mapping an indirect relationship between elements a primary document of an ERP system and a contract document. At stage 210, an RTB application can receive, via a GUI, a selection of the primary table. This can be identical to stage 110 of FIG. 1. For example, the GUI may be rendered within a browser-based environment, a standalone application, or a native SAP interface, depending on the deployment architecture of the plugin. The selection can be made from a dropdown menu, search field, or other input component configured to present available data sources.

After a primary source is selected, the GUI can present one or more options for defining the type of relationship to be established between entries in the primary table and elements of a contract data source, including direct and indirect relationship types.

At stage 220, the RTB application can receive, from a GUI, a selection of an indirect relationship type. An indirect relationship type corresponds to a mapping configuration in which the primary table does not contain a direct reference to a contract or contract item. Instead, an intermediate object—such as a billing element—is used to establish an association between transactional records and the relevant contract data.

The selection of the indirect relationship type configures the RTB application to operate in a mode that supports mapping via intermediate entities. In some embodiments, the RTB application stores the relationship type selection and dynamically modifies the GUI to present appropriate field pairing options for indirect mapping. This selection informs subsequent configuration stages in which users define how billing elements or similar objects are linked to contract items to support reconciliation and billing logic when direct identifiers are not available in the transactional data.

At stage 230, the RTB application can display, in the GUI, a field pairing interface configured for indirect mapping. The field pairing comprises a first field corresponding to a contract billing object and a second field corresponding to a billing element in the primary table.

The contract billing object can represent an identifier within the contract data source that is used to logically associate one or more contract items with a billing entity, such as a WBS billing element or other intermediate reference. The billing element in the primary table corresponds to a field—such as an internal object number field (“OBJNR”) or project number (“PSPNR”) in the ACDOCA table—that identifies a cost or revenue-bearing structure used in the financial records of the ERP system.

This configuration differs from the direct relationship type in that the mapping is not made between values that directly identify the contract and the transactional record. Instead, the mapping is established through a billing element that serves as an intermediary reference. In a direct relationship, the primary table contains explicit identifiers (e.g., contract number and item number) that can be directly matched to the contract file. By contrast, in an indirect relationship, the transactional record refers only to a billing element, and it is the billing element that must be mapped to the relevant contract item.

The RTB application can populate the selectable field options in the GUI based on metadata retrieved from the primary table and the contract file, allowing the user to define a logical association between financial posting data and contractual obligations via the intermediate billing structure. This setup enables the RTB application to resolve mappings even in cases where the primary table lacks explicit contract identifiers.

At stage 240, the RTB application can receive, via the GUI, user-provided input values for the defined mapping fields. Specifically, the RTB application receives a first value corresponding to a contract billing object and a second value corresponding to a billing element in the primary table.

The first value represents an identifier in the contract file that is used to reference a contract billing object, such as a contract item, billing node, or other intermediary element used to organize billing logic within the contractual structure. The second value represents an identifier for a billing-related object within the transactional data stored in the primary table, such as a BS billing element or internal object number (e.g., OBJNR) recorded in the ACDOCA table.

The user may enter or select the values through GUI controls such as input fields, dropdown menus, or lookup dialogs. In some embodiments, the RTB application can perform validation or lookups in background processes to confirm that the provided values exist in the respective data sources and conform to required formats or domain constraints.

These received values define an indirect mapping, where the billing element serves as a reference point for associating transactional data with contract data. This approach allows the system to establish a logical link between records even when the transactional data lacks a direct reference to a specific contract or contract item. The values are held in memory for subsequent use in creating a persistent mapping entry, as described in Stage 250.

At stage 250, the RTB application can create a mapping entry in a mapping table. This entry associates the contract billing object with the corresponding billing element identified in the primary table.

The mapping table serves as a persistent data structure used to store relationship definitions between contractual references and transactional billing identifiers. In the context of an indirect relationship, the mapping entry enables the RTB application to resolve contract associations by using an intermediate billing structure—such as a WBS billing element—that appears in the transactional data but not in the contract data directly.

Each mapping entry can include at least two key fields: a first field referencing the contract billing object (e.g., a contract item or billing node identifier); and a second field referencing the billing element used in the primary table (e.g., an object number or PSP element recorded in ACDOCA).

By storing this indirect mapping, the RTB application is able to match financial postings to contract obligations based on the presence of a billing element, even in the absence of explicit contract references in the transactional data. This functionality supports billing, reconciliation, and reporting processes that depend on logical linkage between contract structures and ERP financial records. In some embodiments, the mapping entry may also include metadata such as the mapping type (indirect), timestamp, user ID, or versioning information to support auditability and downstream processing.

In some embodiments, the RTB application can support a category of indirect relationship known as an intercompany relationship, which enables the resolution of transactional records in cases involving internal billing between company codes under a transfer pricing agreement.

In an intercompany scenario, a sales document or project activity originates in a first company code (referred to herein as company code A), and is associated with a customer that is an internal representation of a second company code (referred to herein as company code B). For example, company code A may supply labor or services—such as employee time or project deliverables—to a project managed under company code B. Under an internal transfer pricing agreement, company code A is permitted to bill company code B for such contributions.

To identify and process relevant transactional records from the Universal Journal table (ACDOCA), the RTB application extracts and evaluates specific fields associated with cross-company postings. These fields may include: the supplying company code (e.g., BUKRS field for company code A), the receiving company code associated with the internal customer or project (e.g., via the customer master or WBS element), and transaction-level indicators identifying intercompany accounting entries, such as document type, line item direction, or partner company code.

The RTB application can support configuration of such intercompany logic as a specialized indirect relationship type, selectable through the GUI. In this configuration, the user specifies a field in the transactional data that captures the delivering company code, and a field or lookup reference that resolves the receiving company code, often derived from the project definition, WBS element, or internal order structure.

This form of indirect mapping enables the plugin to identify and extract ACDOCA records that represent intercompany activity, such as internal billing or transfer postings, based on the occurrence of cross-company interactions. The mapping logic can be used to associate those transactions with corresponding contract items, transfer agreements, or internal chargeback records, even in the absence of direct contract references in the transactional data.

Furthermore, while many use cases for intercompany mappings are cost-related—such as time tracking, resource usage, and service orders—the framework also supports non-cost use cases, including logistical, administrative, and operational entries that require intercompany tracking or reconciliation.

In some embodiments, the intercompany relationship type can also be extended to support service orders, internal orders, or any other controlling object capable of carrying a cross-company dimension. The mapping framework is thus generalized to support a wide range of indirect relationships involving both cost and non-cost transactions, ensuring consistent association of transactional activity with the appropriate contractual or intercompany reference.

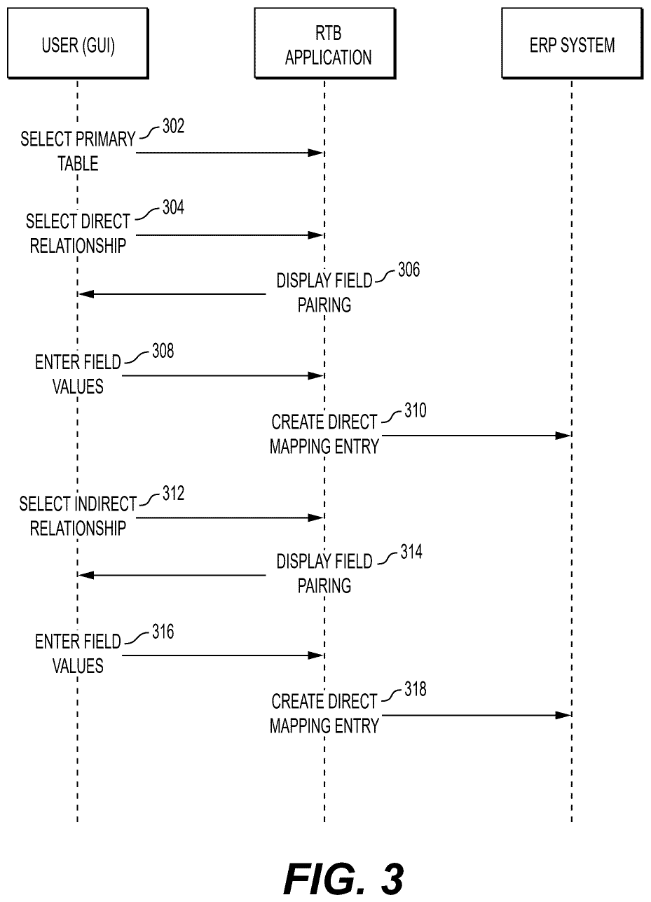

FIG. 3 is a sequence diagram of an example method for providing a GUI for data source customization in an ERP system. At stage 302, a GUI can be rendered by the RTB application, enabling a user to initiate a configuration workflow by selecting a primary data table. The primary table defines the source of transactional records to be used for contract mapping operations. In some embodiments, the primary table corresponds to the Universal Journal table (ACDOCA) in an SAP S/4HANA system. The primary table can include line-item records containing financial, controlling, and project-related attributes.

At stage 304, in response to the selection of the primary table, the RTB application can receive, via the GUI, a selection of a direct relationship type. The direct relationship type indicates that the transactional records stored in the selected primary table include one or more fields that directly reference contract data fields, such as a contract header identifier or a contract item identifier.

At stage 306, based on the direct relationship type selection, the RTB application can dynamically render, in the GUI, a field pairing interface. The field pairing includes a first selectable field that corresponds to a data column in the primary table and a second selectable field that corresponds to a data column in a contract data structure. The plugin application can retrieve metadata definitions for the primary table and contract file to populate the available field options. The purpose of the field pairing is to define a schema-level mapping rule that supports record-level joins between the primary table and the contract data.

At stage 308, the RTB application can receive, via the GUI, a first input value corresponding to the selected primary table field and a second input value corresponding to the selected contract data field. These values define a concrete instance of a mapping rule under the direct relationship model, wherein a value contained in a transactional record is matched directly against a contract reference value.

At stage 310, the RTB application can generate and write a mapping entry into a persistent mapping table. The mapping entry includes a key-value association linking the received primary table value to the received contract file value. This entry is tagged as a direct mapping type and is used at runtime to resolve transactional records in the ERP system to specific contract items based on field-level equivalence.

At stage 312, a separate workflow is initiated in which the plugin application receives, via the GUI, a selection of an indirect relationship type. The indirect relationship type indicates that the primary table does not contain direct contract references, but instead includes references to intermediate objects—such as billing elements—that can be associated with contract items through an external mapping.

At stage 314, in response to the indirect relationship type selection, the RTB application can render, in the GUI, a modified field pairing interface. The interface includes a first selectable field corresponding to a contract billing object, such as a contract item identifier or billing group reference, and a second selectable field corresponding to a billing element present in the primary table. In the context of the ACDOCA table, the billing element may be represented by a project system object such as a WBS element (e.g., identified by the OBJNR or PSPNR fields).

At stage 316, the RTB application can receive, via the GUI, a third input value corresponding to the selected contract billing object and a fourth input value corresponding to the selected billing element field in the primary table. These values define an indirect association between the billing reference present in transactional data and the contract item to which the billing element is logically assigned.

At stage 318, in response to the received values, the RTB application can create and store a second mapping entry in the mapping table. The entry associates the contract billing object with the billing element and is marked as an indirect mapping type. During runtime execution, the plugin application can use the mapping table to resolve financial or controlling transactions to contract items by dereferencing the billing element identifier contained in the transactional record.

The RTB application can use the mapping table when processing transaction records. For example, at runtime, the RTB application can operate in a processing mode in which it evaluates transactional records originating from the selected primary table (e.g., ACDOCA) and apply previously defined mapping entries to resolve associations between those records and corresponding contract items.

Upon receiving a processing trigger—either as a scheduled batch job, an API call, or an event-based listener attached to data changes in the ERP system—the RTB application can retrieve one or more new or updated records from the primary table. The transactional records are parsed and subjected to a mapping resolution routine as described below.

If the mapping type is identified as a direct relationship, the RTB application can perform a lookup operation using one or more key fields from each transactional record. For example, the plugin may extract the VBELN (contract number) and POSNR (item number) fields from an ACDOCA entry. These extracted values are used as a lookup key against the mapping table, where each entry represents a direct association between the primary table and the contract file.

If a corresponding mapping entry is found, the RTB application associates the transactional record with the contract item referenced in the mapping entry. This resolved association is then output or written to a result table, staging buffer, or passed downstream to a billing, reporting, or analytics module for further processing. In some implementations, the plugin can annotate the record with metadata such as the contract ID, item ID, and mapping type before persisting it.

If the mapping type is identified as an indirect relationship, the RTB application can apply a two-step resolution process. First, the RTB application can extract an intermediate object identifier from the transactional record-typically a billing element, such as a project system WBS element stored in the OBJNR or PSPNR field of the ACDOCA table.

The extracted billing element value is then used as a lookup key against the mapping table, where it is matched to a corresponding contract billing object, such as a contract item, contract node, or billing structure. If a matching entry is found, the plugin infers the associated contract item and creates a logical link between the transactional record and the appropriate contract reference.

As with the direct mapping scenario, the resolved association can be written to a result table, forwarded to a billing engine, or used in generating reconciliation reports. In some embodiments, the RTB application can flag any transactional records that do not resolve to a contract item—either due to missing mappings or data inconsistencies—and optionally log such entries for manual review or exception handling.

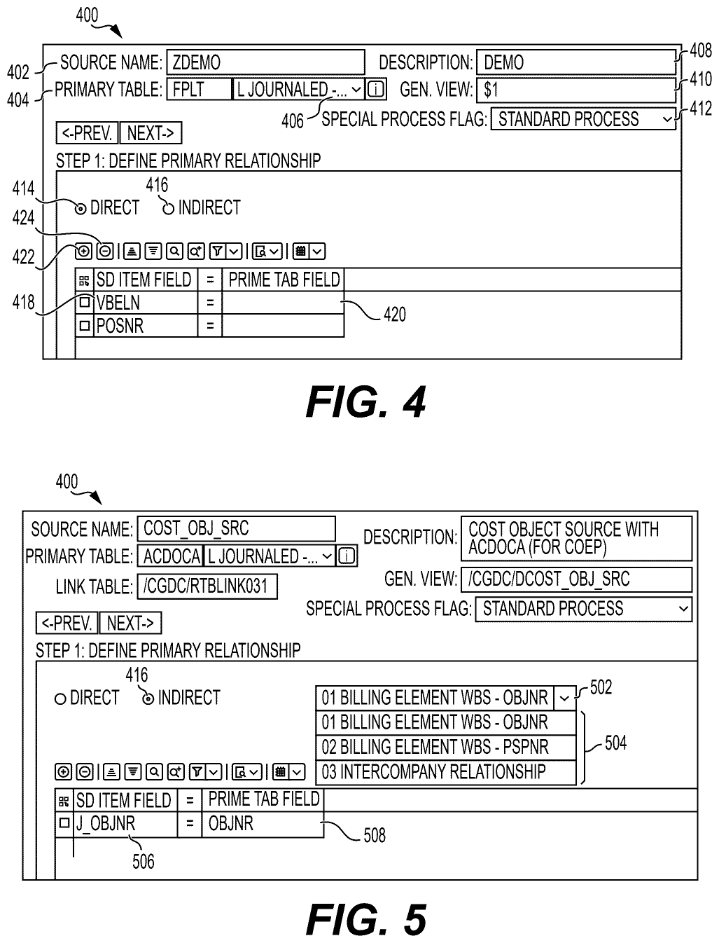

FIG. 4 is an illustration of an example GUI for enabling a user to configure mapping relationships between contract data and transactional records stored in an ERP system. The GUI 400 can be implemented as part of a browser-based plugin, an SAP Fiori tile, or a native ERP-integrated application interface.

The GUI 400 includes a source name field 402, which allows a user to specify or select a source document corresponding to the contract. This may reference a specific contract file, data structure, or document identifier in an external or internal contract repository.

A primary table field 404 is provided for the user to input or select the primary source table that contains the transactional records to be processed. In some implementations, the primary table may correspond to ACDOCA, the Universal Journal table in SAP S/4HANA, or another relevant transactional or financial table.

A journaled drop-down list 406 enables the user to indicate whether the plugin should operate on journal line items or journal totals records. This selection determines the granularity of the data to be used for mapping and subsequent processing.

The GUI 400 further includes a description field 408, which allows the user to input a textual label or descriptor for the mapping configuration session. This description may be used for versioning, auditing, or administrative reference.

A general view window 410 is also provided to present an overview of the mapping configuration in progress. The general view window 410 may display existing mappings, unresolved items, or summary statistics relevant to the current configuration.

A special processing flag 412 is included to allow the user to specify whether the mapping logic should follow a standard or special processing path. This may influence downstream behavior such as condition evaluation, runtime rule selection, or exception handling.

The GUI 400 includes selectable GUI elements for defining the primary relationship type. Specifically, the GUI includes a direct relationship selector 414 and an indirect relationship selector 416. In the embodiment shown, the direct relationship selector 414 is selected, thereby configuring the GUI to operate in direct mapping mode.

In response to the selection of direct relationship type, the GUI 400 in FIG. 4 displays a set of paired fields comprising contract item fields 418 and corresponding primary table fields 420. Each pairing defines a direct relationship between a data element in the contract file and a corresponding data element in the primary table.

To manage field pairings, the GUI 400 includes an add button 422 and a remove button 424. The add button 422 allows a user to insert a new field pairing into the configuration, while the remove button 424 allows a user to delete an existing pairing. These controls enable dynamic adjustment of the mapping schema within a single user session.

FIG. 5 is an illustration of an alternate configure of the GUI 400 where the indirect relationship selector 416 is selected. Upon selection of the indirect relationship mode, the interface dynamically reconfigures to support the definition of indirect mapping relationships between contract data and transactional records.

In this mode, the GUI 400 displays a relationship type dropdown 502, enabling the user to select a specific type of indirect relationship. The relationship type dropdown 502 may be implemented as a combo box, select list, or other graphical control, and is populated with one or more predefined indirect mapping types. In some embodiments, selectable options may include: an OBJNR WBS billing element type, which uses the SAP object number of a Work Breakdown Structure (WBS) element as an intermediary reference; a PSPNR WBS billing element type, which uses the internal SAP WBS element identifier; and an intercompany relationship type, which associates transactional records with contract items across organizational entities based on billing or ledger references.

Selection of a relationship type from the dropdown 502 modifies the underlying mapping logic that will be applied during runtime resolution of transactional data.

The GUI 400 further displays a contract item field 506 and a primary table field 508, representing the two components of an indirect field pairing. The contract item field 506 corresponds to a contract-side identifier, such as a billing node, contract item, or external reference. The primary table field 508 corresponds to the intermediary billing element contained in the selected primary table, such as a WBS element identifier embedded in a transactional record in ACDOCA.

The user may populate the contract item field 506 and primary table field 508 by selecting available fields from lookup controls, dropdowns, or by manual input. These fields are used to define a logical association between contract structures and financial postings, even in cases where the transactional record lacks a direct contract reference.

The indirect relationship configuration shown in GUI 400 enables flexible resolution of complex billing scenarios, such as project-based billing, intercompany transactions, or situations where multiple transactional sources are mapped to a unified contract framework.

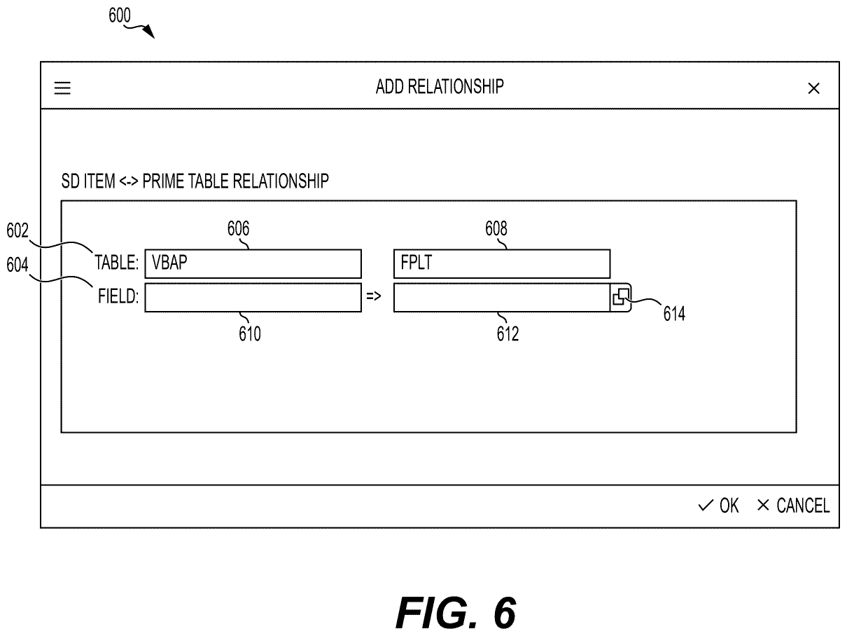

FIG. 6 is an illustration of a dedicated relationship definition window 600, which can be presented to the user when the user initiates an action to add a new mapping relationship. The window may be triggered from the main configuration interface (e.g., GUI 400) in response to selection of an “add” control or similar user interface element.

The window includes a table selector 602, which allows the user to specify the source tables involved in the mapping relationship. The table selector 602 comprises two sub-selectors: a contract table selector 606 and a primary table selector 608. The contract table selector 606 enables the user to choose a contract-related data source, such as a structured contract file, a table containing contract item metadata, or a dynamically generated contract view. The primary table selector 608 allows the user to identify the ERP transactional table that contains the data elements to be mapped. In some embodiments, the primary table selector 608 includes options such as ACDOCA or custom line-item summary tables.

Below the table selectors, the window includes input fields 604 for defining the specific field-level mapping. These input fields include a contract item field 610 and a primary table field 612. The contract item field 610 allows the user to specify or select a data column from the selected contract table (e.g., a contract item ID or billing reference). The primary table field 612 allows the user to specify a field from the primary transactional table (e.g., a document number, WBS element, or object number).

To assist in field selection, the window also includes a lookup button 614. When the lookup button 614 is selected, the system retrieves metadata associated with the selected tables and displays a secondary window or modal containing a populated list of available fields. This list may include field names, descriptions, data types, and sample values, and may support filtering or search functionality to aid in user selection. The lookup function ensures that field selection is constrained to valid table columns and improves consistency across mapping entries.

The relationship definition window of FIG. 6 enables granular, field-level control over how data from the contract table is associated with data in the primary table. Once defined, the relationship can be added to the overall mapping configuration and stored in a mapping table for use during runtime resolution and processing.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for configuring and storing mapping relationships between transactional records and contract data in an enterprise resource planning (“ERP”) environment, comprising:
receiving, from a graphical user interface (“GUI”), a selection of a primary table;
receiving, from the GUI, a selection of a relationship type, the relationship type being one of a direct relationship or an indirect relationship;
in an instance where the relationship type selection is a direct relationship,
displaying, in the GUI, a field pairing interface comprising a first field corresponding to a data element in the primary table, and a second field corresponding to a data element in the contract file;
receiving, from the GUI, input values corresponding to the data element in the primary table and data element in the contract file; and
creating, in the mapping table, a first mapping entry in a mapping table that associates the value corresponding to the selected field from the primary table with the value corresponding to the selected field from the contract file; and
in an instance where the relationship type selection is an indirect relationship,
displaying, in the GUI, a second field pairing comprising a third field and a fourth field, the third field corresponding to a contract billing object and the fourth field corresponding to a primary table billing element;
receiving, from the GUI, user-provided input values for the contract billing object and the primary table billing element; and
creating, in the mapping table, a second mapping entry in a mapping table that associates the value corresponding to the contract billing object with the value corresponding to the primary table billing element.

2. The method of claim 1, wherein the relationship type selection comprises an intercompany relationship type, and wherein creating the second mapping entry comprises:
associating a first value corresponding to a delivering company code in the primary table with a second value corresponding to a receiving company code derived from a project or internal customer; and
resolving, during runtime processing, transactional records representing cross-company postings by identifying entries in the primary table in which the delivering company code and the receiving company code satisfy an intercompany billing condition.

3. The method of claim 1, wherein the input values received for the direct relationship type are validated by confirming the existence of the contract reference and verifying that the primary table value conforms to a predetermined format.

4. The method of claim 1, wherein the mapping table includes an entry type indicator, and each of the first mapping entry and second mapping entry is stored with a corresponding indicator denoting a direct or indirect relationship type.

5. The method of claim 1, further comprising resolving, during runtime processing, transactional records in the primary table by applying a lookup operation that uses the first mapping entry to match a transactional field value to a contract item identifier.

6. The method of claim 1, further comprising resolving, during runtime processing, transactional records in the primary table by applying a dereferencing operation that uses the second mapping entry to map a billing element value in the transactional record to a contract billing object.

7. The method of claim 1, further comprising generating, in response to mapping resolution, an annotated transaction record that includes an identifier of the associated contract item and an indicator of the mapping method used.

8. A non-transitory, computer-readable medium containing instructions that, when executed by a hardware-based processor, causes the processor to perform stages for configuring and storing mapping relationships between transactional records and contract data in an enterprise resource planning (“ERP”) environment, comprising:
receiving, from a graphical user interface (“GUI”), a selection of a primary table;
receiving, from the GUI, a selection of a relationship type, the relationship type being one of a direct relationship or an indirect relationship;
in an instance where the relationship type selection is a direct relationship,
displaying, in the GUI, a field pairing interface comprising a first field corresponding to a data element in the primary table, and a second field corresponding to a data element in the contract file;
receiving, from the GUI, input values corresponding to the data element in the primary table and data element in the contract file; and
creating, in the mapping table, a first mapping entry in a mapping table that associates the value corresponding to the selected field from the primary table with the value corresponding to the selected field from the contract file; and
in an instance where the relationship type selection is an indirect relationship,
displaying, in the GUI, a second field pairing comprising a third field and a fourth field, the third field corresponding to a contract billing object and the fourth field corresponding to a primary table billing element;
receiving, from the GUI, user-provided input values for the contract billing object and the primary table billing element; and
creating, in the mapping table, a second mapping entry in a mapping table that associates the value corresponding to the contract billing object with the value corresponding to the primary table billing element.

9. The non-transitory, computer-readable medium of claim 8, wherein the relationship type selection comprises an intercompany relationship type, and wherein creating the second mapping entry comprises:
associating a first value corresponding to a delivering company code in the primary table with a second value corresponding to a receiving company code derived from a project or internal customer; and
resolving, during runtime processing, transactional records representing cross-company postings by identifying entries in the primary table in which the delivering company code and the receiving company code satisfy an intercompany billing condition.

10. The non-transitory, computer-readable medium of claim 8, wherein the input values received for the direct relationship type are validated by confirming the existence of the contract reference and verifying that the primary table value conforms to a predetermined format.

11. The non-transitory, computer-readable medium of claim 8, wherein the mapping table includes an entry type indicator, and each of the first mapping entry and second mapping entry is stored with a corresponding indicator denoting a direct or indirect relationship type.

12. The non-transitory, computer-readable medium of claim 8, the stages further comprising resolving, during runtime processing, transactional records in the primary table by applying a lookup operation that uses the first mapping entry to match a transactional field value to a contract item identifier.

13. The non-transitory, computer-readable medium of claim 8, the stages further comprising resolving, during runtime processing, transactional records in the primary table by applying a dereferencing operation that uses the second mapping entry to map a billing element value in the transactional record to a contract billing object.

14. The non-transitory, computer-readable medium of claim 8, the stages further comprising generating, in response to mapping resolution, an annotated transaction record that includes an identifier of the associated contract item and an indicator of the mapping method used.

15. A system for configuring and storing mapping relationships between transactional records and contract data in an enterprise resource planning (“ERP”) environment, the system comprising:
at least one physical non-transitory, computer-readable medium including instructions; and
at least one processor that executes the instructions to perform stages comprising:
receiving, from a graphical user interface (“GUI”), a selection of a primary table;
receiving, from the GUI, a selection of a relationship type, the relationship type being one of a direct relationship or an indirect relationship;
in an instance where the relationship type selection is a direct relationship,
displaying, in the GUI, a field pairing interface comprising a first field corresponding to a data element in the primary table, and a second field corresponding to a data element in the contract file;
receiving, from the GUI, input values corresponding to the data element in the primary table and data element in the contract file; and
creating, in the mapping table, a first mapping entry in a mapping table that associates the value corresponding to the selected field from the primary table with the value corresponding to the selected field from the contract file; and
in an instance where the relationship type selection is an indirect relationship,
displaying, in the GUI, a second field pairing comprising a third field and a fourth field, the third field corresponding to a contract billing object and the fourth field corresponding to a primary table billing element;
receiving, from the GUI, user-provided input values for the contract billing object and the primary table billing element; and
creating, in the mapping table, a second mapping entry in a mapping table that associates the value corresponding to the contract billing object with the value corresponding to the primary table billing element.

16. The system of claim 15, wherein the relationship type selection comprises an intercompany relationship type, and wherein creating the second mapping entry comprises:
associating a first value corresponding to a delivering company code in the primary table with a second value corresponding to a receiving company code derived from a project or internal customer; and
resolving, during runtime processing, transactional records representing cross-company postings by identifying entries in the primary table in which the delivering company code and the receiving company code satisfy an intercompany billing condition.

17. The system of claim 15, wherein the input values received for the direct relationship type are validated by confirming the existence of the contract reference and verifying that the primary table value conforms to a predetermined format.

18. The system of claim 15, wherein the mapping table includes an entry type indicator, and each of the first mapping entry and second mapping entry is stored with a corresponding indicator denoting a direct or indirect relationship type.

19. The system of claim 15, the stages further comprising resolving, during runtime processing, transactional records in the primary table by applying a lookup operation that uses the first mapping entry to match a transactional field value to a contract item identifier.

20. The system of claim 15, the stages further comprising resolving, during runtime processing, transactional records in the primary table by applying a dereferencing operation that uses the second mapping entry to map a billing element value in the transactional record to a contract billing object.
